(19) United States
(12) Patent Application Publication
(10) Pub. No.: US 2026/0204494 A1
(43) Pub. Date: Jul. 16, 2026

(54) SWITCHING APPARATUS

(71) Applicant: Alps Alpine Co., Ltd., Tokyo (JP)

(72) Inventor: Yuki YASHIMA, Miyagi-ken (JP)

(21) Appl. No.: 19/448,667

(22) Filed: Jan. 14, 2026

(30) Foreign Application Priority Data
Jan. 15, 2025 (JP) 2025-005739

(51) Int. Cl. H01H 13/04; H01H 13/48; H01H 13/52

(52) U.S. Cl. CPC H01H 13/04; H01H 13/48; H01H 13/52

(57) ABSTRACT

A switching apparatus includes a housing including an accommodating portion configured to accommodate a fixed contact and a movable contact, a movable contact member disposed in the accommodating portion, an operating member configured to press the movable contact member, and a cover member configured to cover a base portion of the operating member. The housing includes a protruding portion projecting from a side surface of the housing. The cover member includes a hook extending downward from an edge of the cover member, the hook having an opening. The hook engages the protruding portion when the protruding portion is fitted in the opening. Side surfaces of the protruding portion include a restricting portion configured to restrict movement of the hook by coming into contact with side edges of the opening of the hook.

### CLAIM OF PRIORITY

This application claims benefit of Japanese Patent Application No. 2025-005739 filed on January 15, 2025, which is hereby incorporated by reference.

### BACKGROUND OF THE INVENTION

### 1. Field of the Invention

The present invention relates to a switching apparatus.

### 2. Description of the Related Art

International Publication No. WO2023/157843 discloses a technique for securing a frame to a housing by placing the frame in an overlapping manner on an upper surface of the housing and engaging hooks of the frame with claw portions provided on side surfaces of the housing.

However, in the conventional switching apparatus, when the apparatus is mounted on a substrate by reflow soldering, reflow heat is applied to the housing, causing the housing to soften. As a result, the engagement between the hooks of the frame and protruding portions of the housing may become loosened, and consequently, when vibration is applied, rattling noise may be generated due to looseness of the cover member with respect to the housing.

### SUMMARY OF THE INVENTION

A switching apparatus according to an aspect of the present invention includes a housing including an accommodating portion configured to accommodate a fixed contact and a movable contact, a movable contact member disposed in the accommodating portion, an operating member configured to press the movable contact member, and a cover member configured to cover a base portion of the operating member. The housing includes a protruding portion projecting from a side surface of the housing. The cover member includes a hook extending downward from an edge of the cover member, the hook having an opening. The hook engages the protruding portion when the protruding portion is fitted in the opening. Side surfaces of the protruding portion include a restricting portion configured to restrict movement of the hook by coming into contact with side edges of the opening of the hook.

In a switching apparatus according to one embodiment of the present disclosure, even when the switching apparatus is mounted on a substrate by reflow soldering, rattling noise of the cover member with respect to the housing can be substantially prevented.

### BRIEF DESCRIPTION OF THE DRAWINGS

FIG. 1 is an external perspective view of a switching apparatus according to one embodiment;

FIG. 2 is an exploded perspective view of the switching apparatus according to one embodiment;

FIG. 3 is a cross-sectional perspective view of the switching apparatus according to one embodiment;

FIG. 4 is a plan view of a housing of the switching apparatus according to one embodiment;

FIG. 5 is a right-side view of the switching apparatus according to one embodiment;

FIG. 6 is a partially enlarged view of the switching apparatus illustrated in FIG. 5;

FIG. 7 is a plan view of the switching apparatus according to one embodiment;

FIG. 8 is a partially enlarged view of the switching apparatus illustrated in FIG. 7; and

FIG. 9 is a partially enlarged cross-sectional view of the switching apparatus according to one embodiment.

### DESCRIPTION OF THE PREFERRED EMBODIMENTS

One embodiment will be described hereinbelow with reference to the drawings. In the following description, for convenience, the Z-axis direction in the drawings is defined as a vertical direction, the Y-axis direction as a lateral direction, and the X-axis direction as a front-rear direction. The positive Z-axis direction is upward, and the positive Y-axis direction is rightward, and the positive X-axis direction is forward.

### Outline of Switching Apparatus 100

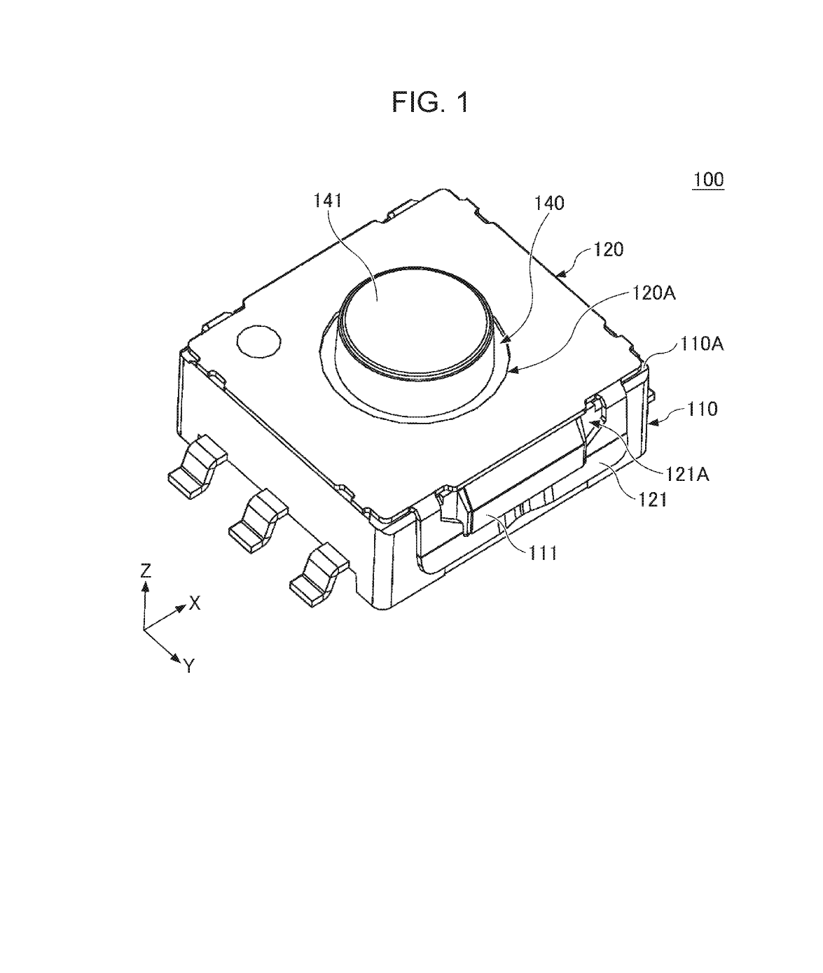

FIG. 1 is an external perspective view of a switching apparatus 100 according to one embodiment. As illustrated in FIG. 1, the switching apparatus 100 is configured such that a cover member 120 is placed over an upper surface 110A of a housing 110, and a base portion 142 of a stem 140 is covered by the cover member 120.

As illustrated in FIG. 1, a circular opening 120A is formed in a central portion of the cover member 120. A columnar operating portion 141 provided at a central portion of the stem 140 extends through the opening 120A. Accordingly, the operating portion 141 of the stem 140 projects upward (in the positive Z-axis direction) beyond the opening 120A.

The switching apparatus 100 is configured to allow an operator to press the operating portion 141 of the stem 140 downward (in the negative Z-axis direction), thereby enabling the switching apparatus 100 to be switched in two stages from a switch-off state to a first switch-on state and a second switch-on state.

### Configuration of Switching Apparatus 100

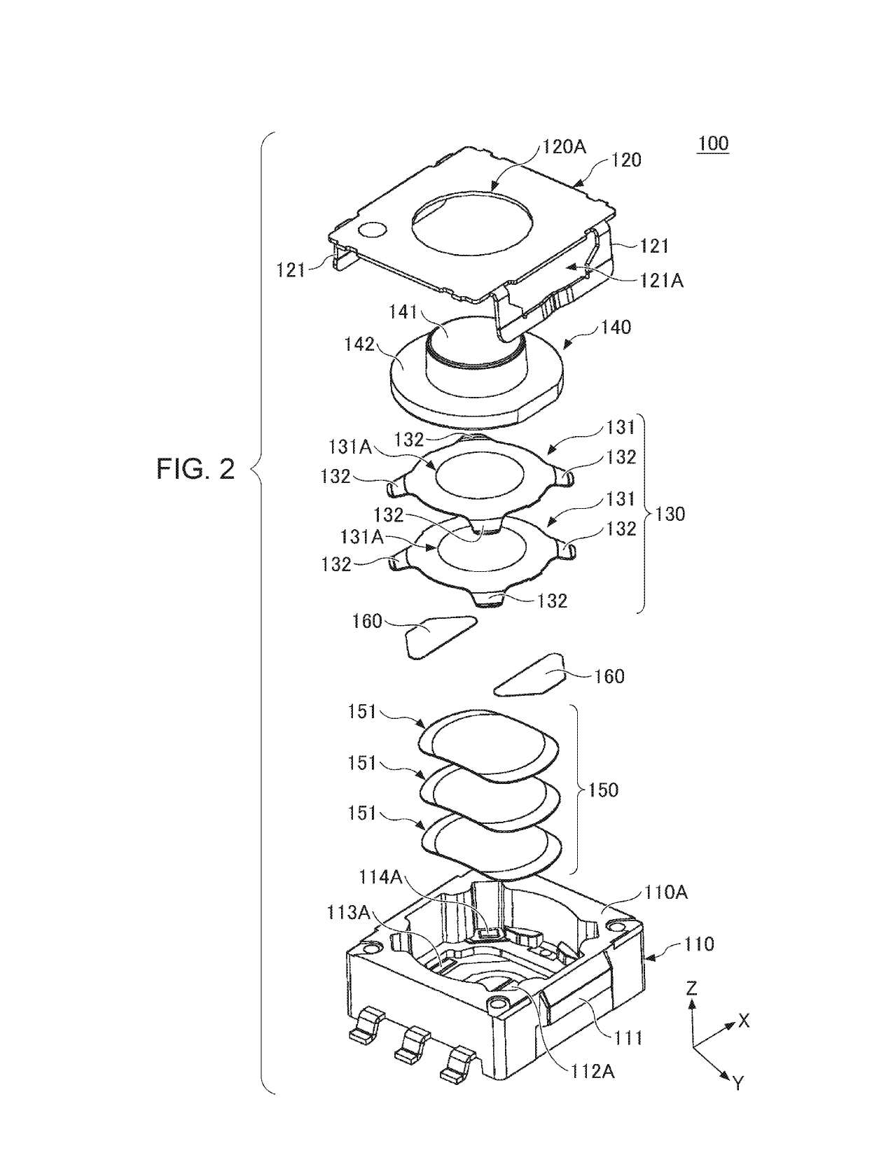

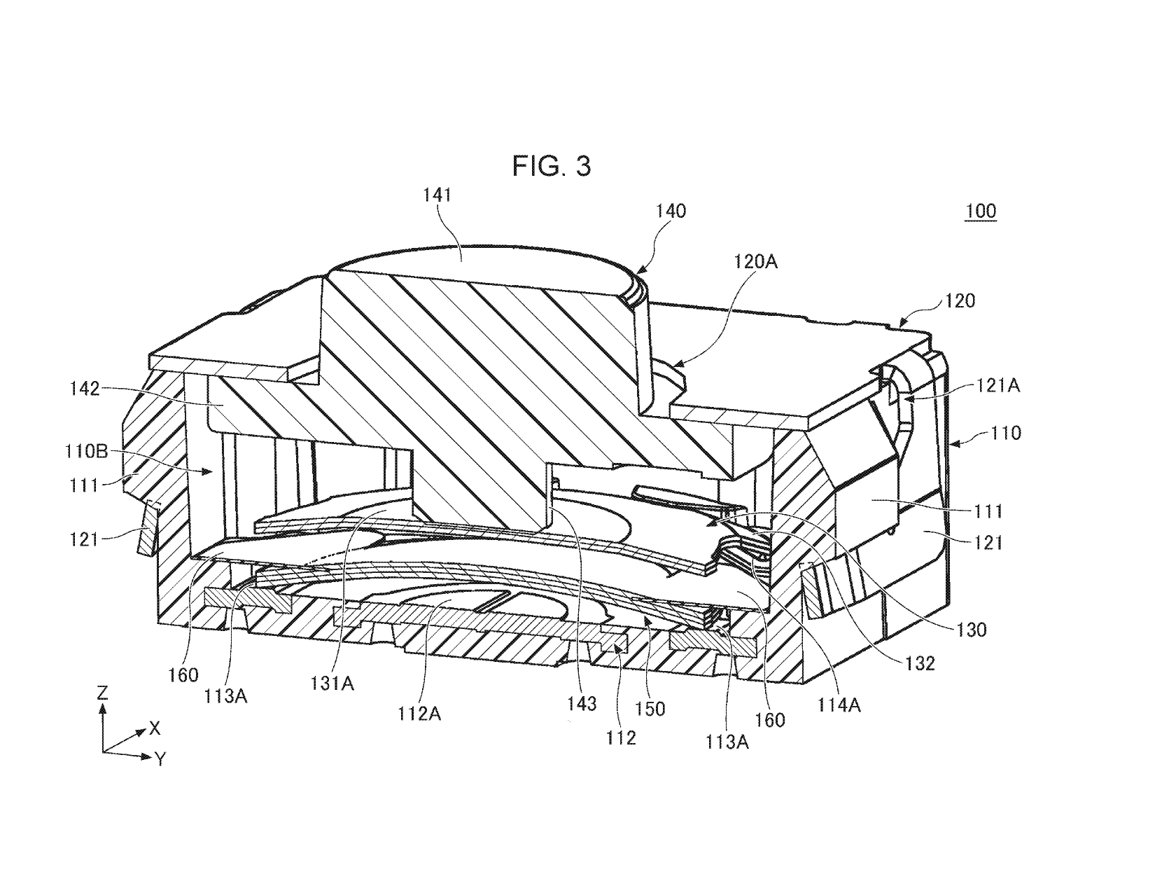

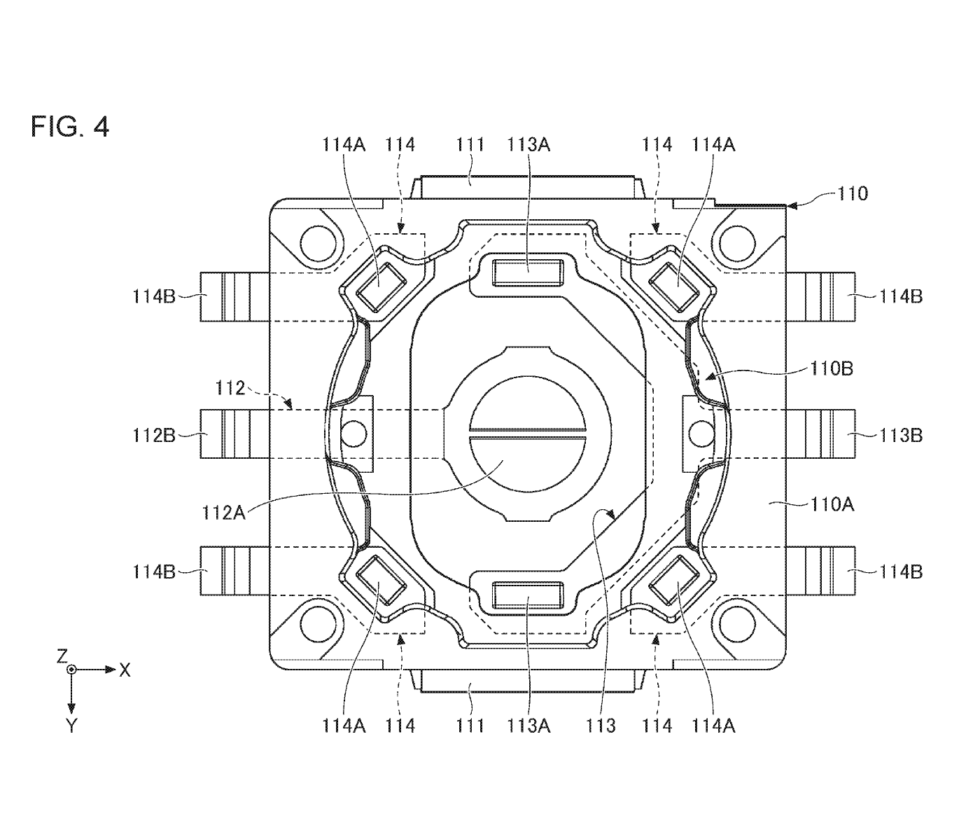

FIG. 2 is an exploded perspective view of the switching apparatus 100 according to one embodiment. FIG. 3 is a cross-sectional perspective view of the switching apparatus 100 according to one embodiment. FIG. 4 is a plan view of the housing 110 of the switching apparatus 100 according to one embodiment. As illustrated in FIGS. 2 and 3, the switching apparatus 100 includes the housing 110, the cover member 120, a first movable contact member 130, the stem 140, a second movable contact member 150, and insulating members 160.

The housing 110 is a container-like member having a thin rectangular parallelepiped shape in the vertical direction (Z-axis direction). The housing 110 has a generally square shape in top view. The housing 110 has an accommodating portion 110B that is recessed downward from the upper surface 110A and is circular in plan view as viewed from above (in the positive Z-axis direction). The accommodating portion 110B accommodates the stem 140, the first movable contact member 130, and the second movable contact member 150. For example, the housing 110 is formed of a relatively hard insulating material (for example, hard resin) by insert molding.

A protruding portion 111 that projects outward is formed on each of a pair of left and right side surfaces of the housing 110. When the cover member 120 is attached to the upper surface 110A of the housing 110, the protruding portions 111 are fitted into a corresponding one of openings 121A of hooks 121 of the cover member 120, thereby engaging the hooks 121 and fixing the cover member 120 to the housing 110.

As illustrated in detail in FIG. 4, a central fixed contact 112A, two first peripheral fixed contacts 113A, and four second peripheral fixed contacts 114A are provided on the inner bottom surface of the accommodating portion 110B of the housing 110.

The central fixed contact 112A is provided at the center of the inner bottom surface of the accommodating portion 110B and faces a central portion of the rear surface of the second movable contact member 150.

The two first peripheral fixed contacts 113A are provided on the inner bottom surface of the accommodating portion 110B, on both left and right outer sides of the central fixed contact 112A. On each of the two first peripheral fixed contacts 113A, a respective one of a pair of left and right arc-shaped edge portions of the second movable contact member 150 is placed.

The four second peripheral fixed contacts 114A are provided at regular intervals (i.e., at 90-degree intervals) along the outer peripheral edge of the inner bottom surface of the accommodating portion 110B. On each of the four second peripheral fixed contacts 114A, a respective one of leg portions 132 of the first movable contact member 130 is placed.

As illustrated in FIG. 4, a central fixed contact member 112, a first peripheral fixed contact member 113, and four second peripheral fixed contact members 114 are embedded in the bottom of the housing 110 by insert molding. The central fixed contact member 112, the first peripheral fixed contact member 113, and the four second peripheral fixed contact members 114 are formed of a conductive plate material (for example, a metal plate).

As illustrated in FIG. 4, the central fixed contact member 112 is integrally formed with the central fixed contact 112A. The central fixed contact member 112 includes an external connection terminal 112B that projects from a rear side surface (on the negative X-axis side) of the housing 110.

As illustrated in FIG. 4, the first peripheral fixed contact member 113 is integrally formed with two first peripheral fixed contacts 113A. The first peripheral fixed contact member 113 includes an external connection terminal 113B that projects from a front side surface (on the positive X-axis side) of the housing 110.

As illustrated in FIG. 4, each of the four second peripheral fixed contact members 114 is integrally formed with a second peripheral fixed contact 114A. Each of the four second peripheral fixed contact members 114 includes an external connection terminal 114B that projects from a front (on the positive X-axis side) or rear side surface (on the negative X-axis side) of the housing 110.

The first movable contact member 130 is provided in the accommodating portion 110B of the housing 110, below the stem 140 (on the negative Z-axis side) and above the second movable contact member 150 (on the positive Z-axis side). The first movable contact member 130 is configured by stacking a plurality of metallic snap-action domes 131 (two in the present embodiment). The metallic snap-action dome 131 is a dome-shaped member made of a thin metal plate and configured to perform a snap action. The metallic snap-action dome 131 has a circular shape in plan view as viewed from above (in the positive Z-axis direction). At the center of the metallic snap-action dome 131, a flat portion 131A that is circular in plan view as viewed from above (in the positive Z-axis direction) is formed.

The four leg portions 132 that project outward in the radial direction are provided at regular intervals (i.e., at 90-degree intervals) along the outer peripheral edge of the metallic snap-action dome 131. Each of the four leg portions 132 is placed on a respective one of the four second peripheral fixed contacts 114A provided on the inner bottom surface of the accommodating portion 110B of the housing 110. This enables the first movable contact member 130 to be stably supported by the four leg portions 132 and to be electrically connected to the four second peripheral fixed contacts 114A.

The first movable contact member 130 is a so-called "snap spring". When a central portion thereof (that is, the flat portion 131A) is pressed from above and a predetermined pressing load is exceeded, an apex thereof rapidly undergoes elastic deformation into a recessed shape (snap action). This causes the central portion of the rear surface of the first movable contact member 130 to come into contact with the second movable contact member 150, thereby being electrically connected to each of the two first peripheral fixed contacts 113A via the second movable contact member 150. As a result, the first movable contact member 130 is capable of electrically connecting each of the four second peripheral fixed contacts 114A and a respective one of the two first peripheral fixed contacts 113A to each other via the first movable contact member 130. When pressing of the central portion is released, the first movable contact member 130 returns to its original convex shape by an elastic force.

The first movable contact member 130 may include one or three or more metallic snap-action domes 131. The load characteristics of the first movable contact member 130 may be controlled by adjusting the number of metallic snap-action domes 131.

The second movable contact member 150 is provided in the accommodating portion 110B of the housing 110, below the first movable contact member 130 (on the negative Z-axis side), and above the inner bottom surface of the accommodating portion 110B of the housing 110 (on the positive Z-axis side). The second movable contact member 150 is configured by stacking a plurality of metallic snap-action domes 151 (three in the present embodiment). The metallic snap-action dome 151 is a dome-shaped member made of a thin metal plate and capable of performing a snap action. The metallic snap-action dome 151 has an elliptical shape that is long in the lateral direction (Y-axis direction) in plan view as viewed from above (in the positive Z-axis direction).

The second movable contact member 150 is placed such that each of a pair of left and right arc-shaped edge portions thereof is supported on a respective one of the two first peripheral fixed contacts 113A provided on the inner bottom surface of the accommodating portion 110B of the housing 110. This enables the second movable contact member 150 to be stably supported at two points by the pair of left and right arc-shaped edge portions, and to be electrically connected to each of the two first peripheral fixed contacts 113A. This causes the central portion of the rear surface of the second movable contact member 150 to face the central fixed contact 112A.

The second movable contact member 150 is a so-called "snap spring". When a central portion thereof is pressed from above and a predetermined pressing load is exceeded, an apex thereof rapidly undergoes elastic deformation into a recessed shape (snap action). This causes the central portion of the rear surface of the second movable contact member 150 to come into contact with the central fixed contact 112A, thereby being electrically connected to the central fixed contact 112A. As a result, the second movable contact member 150 is capable of electrically connecting the central fixed contact 112A and each of the two first peripheral fixed contacts 113A to each other via the second movable contact member 150. When pressing of the central portion is released, the second movable contact member 150 returns to its original convex shape by an elastic force.

The second movable contact member 150 may include two or fewer or four or more metallic snap-action domes 151. The load characteristics of the second movable contact member 150 may be controlled by adjusting the number of metallic snap-action domes 151.

The stem 140 is an example of the "operating member". The stem 140 is a member that is pressed downward (in the negative Z-axis direction) by an operator. The stem 140 is disposed, in the accommodating portion 110B of the housing 110, above the first movable contact member 130 (on the positive Z-axis side) and is movable in the vertical direction (Z-axis direction). The stem 140 is placed on the upper surface 110A and is fixed by the cover member 120 in a state in which the stem 140 closes the accommodating portion 110B of the housing 110. The stem 140 is formed of a hard resin material or an elastic resin material. The stem 140 includes the operating portion 141, the base portion 142, and a pressing portion 143.

The base portion 142 is a horizontal flat portion provided around the operating portion 141. The base portion 142 has a circular shape in plan view as viewed from above (in the positive Z-axis direction). The base portion 142 is integrally formed with the operating portion 141 and supports the operating portion 141 so as to be movable upward and downward.

The operating portion 141 is provided at a central portion of the upper surface of the base portion 142 and has a columnar shape projecting upward from the central portion of the upper surface of the base portion 142. The operating portion 141 is a portion pressed by an operator by passing through the opening 120A of the cover member 120 and projecting upward (in the positive Z-axis direction) beyond the opening 120A of the cover member 120.

The pressing portion 143 is provided at a central portion of the lower surface of the base portion 142 and has a columnar shape that projects downward from the central portion of the lower surface of the base portion 142. The lower surface of the pressing portion 143 is in contact with a central portion of the upper surface of the first movable contact member 130 (i.e., the flat portion 131A). When the stem 140 is moved downward (in the negative Z-axis direction) by a pressing operation performed by an operator, the pressing portion 143 presses the central portion of the upper surface of the first movable contact member 130 with the lower surface thereof.

The cover member 120 is a metallic, horizontal flat plate-shaped member. The cover member 120 has a square shape in top view. The cover member 120 may be placed over the upper surface 110A of the housing 110. Consequently, the cover member 120 closes the accommodating portion 110B of the housing 110.

For example, the cover member 120 is formed by processing a metal plate by press working or the like. In plan view as viewed from above (in the positive Z-axis direction), a circular opening 120A through which the operating portion 141 of the stem 140 projects upward (in the positive Z-axis direction) is formed in a central portion of the cover member 120.

Furthermore, a hook 121 that extends downward is provided on each of left and right edges of the outer peripheral edge of the cover member 120. Each hook 121 has the opening 121A, into which the protruding portion 111 provided on a side surface of the housing 110 is fitted. This enables the hook 121 to be retained to the lower surface of the protruding portion 111, thereby fixing the cover member 120 to the housing 110.

The insulating members 160 are sheet-like members made of an insulating material. The insulating members 160 are provided between the first movable contact member 130 and the second movable contact member 150 in the accommodating portion 110B of the housing 110. When a pressing operation is not performed by an operator and when an operation load of a pressing operation performed by the operator is less than a predetermined value (a value at which the second switch-on state is attained), the insulating members 160 electrically insulate the first movable contact member 130 from the second movable contact member 150. In the present embodiment, a pair of left and right insulating members 160 is provided so as to avoid a central portion of the upper surface of the second movable contact member 150.

### Operation of Switching Apparatus 100

In the switching apparatus 100 according to one embodiment, when no pressing operation is performed by an operator on the operating portion 141 of the stem 140, the operating portion 141 of the stem 140 is in an initial state at a highest position, and both the first movable contact member 130 and the second movable contact member 150 are in initial states in which they are convex upward. At this time, the first movable contact member 130 has each of the four leg portions 132 in contact with a respective one of the four second peripheral fixed contacts 114A, but is not in contact with the second movable contact member 150. At this time, the second movable contact member 150 is in contact with each of the two first peripheral fixed contacts 113A, but is not in contact with the central fixed contact 112A. Accordingly, when no pressing operation is performed by the operator on the operating portion 141 of the stem 140, the switching apparatus 100 according to one embodiment is in a switch-off state.

In the switching apparatus 100 according to one embodiment, when a pressing operation having a predetermined first stroke amount is performed by an operator on the operating portion 141 of the stem 140, the stem 140 moves downward, and the lower surface of the pressing portion 143 of the stem 140 pushes down the central portion of the upper surface of the first movable contact member 130 (i.e., the flat portion 131A). This causes the first movable contact member 130 to elastically deform into a concave shape (snap action), whereby a central portion of the rear surface of the first movable contact member 130 comes into contact with the second movable contact member 150. As a result, in the switching apparatus 100 according to one embodiment, each of the four second peripheral fixed contacts 114A and each of the two first peripheral fixed contacts 113A are electrically connected to each other via the first movable contact member 130 and the second movable contact member 150, thereby establishing the first switch-on state.

Further, in the switching apparatus 100 according to one embodiment, when a pressing operation is performed by an operator on the operating portion 141 of the stem 140 with a predetermined second stroke amount (where the second stroke amount is greater than the first stroke amount), the stem 140 moves further downward, whereby the lower surface of the pressing portion 143 of the stem 140 pushes down a central portion of the second movable contact member 150 via a central portion of the first movable contact member 130. This causes the second movable contact member 150 to elastically deform into a concave shape (snap action), whereby a central portion of the rear surface of the second movable contact member 150 comes into contact with the central fixed contact 112A. As a result, in the switching apparatus 100 according to one embodiment, the central fixed contact 112A and each of the two first peripheral fixed contacts 113A are electrically connected to each other via the second movable contact member 150, thereby establishing the second switch-on state.

### Engagement Configuration of Hook 121

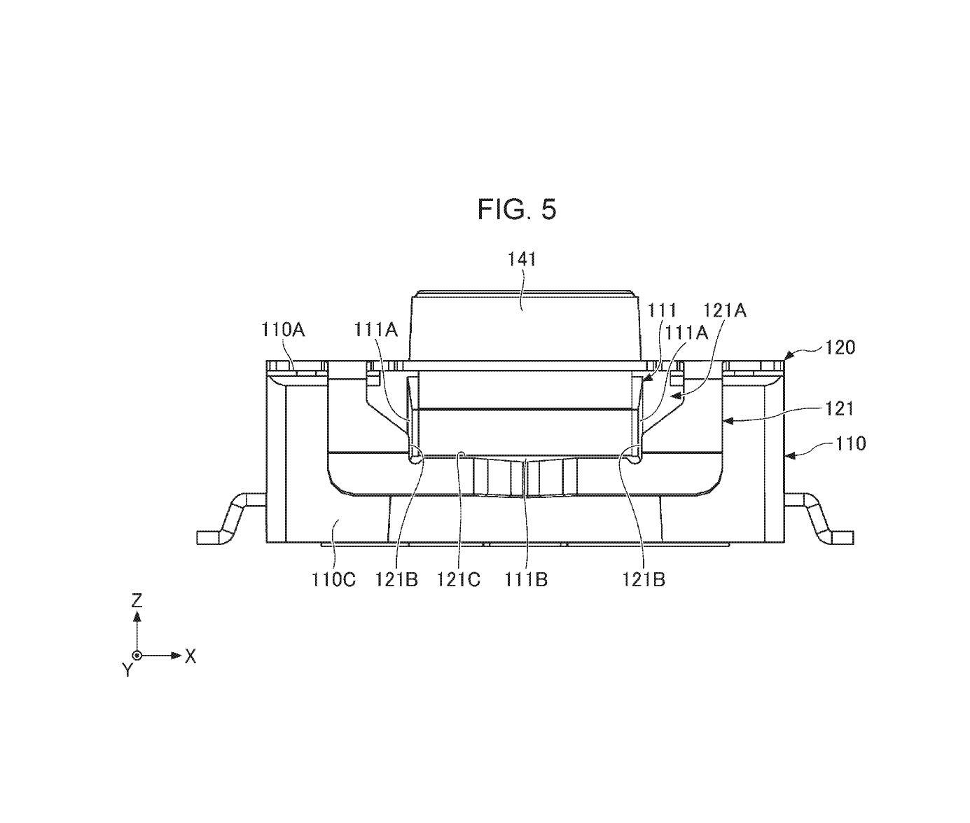

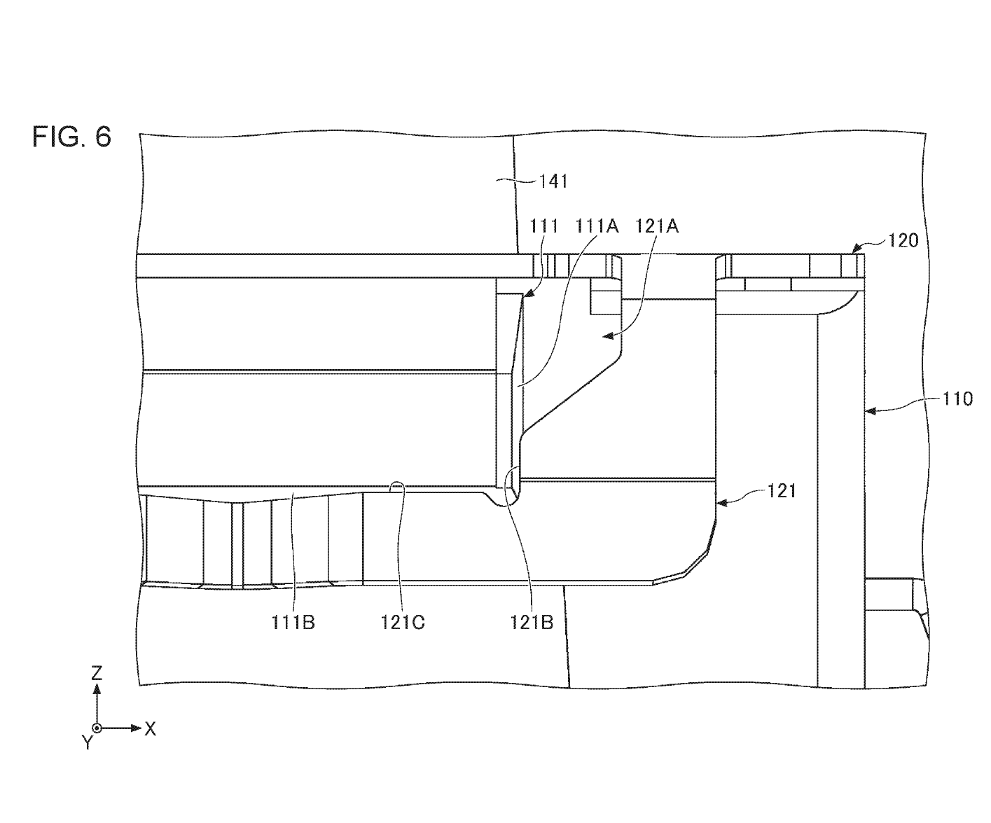

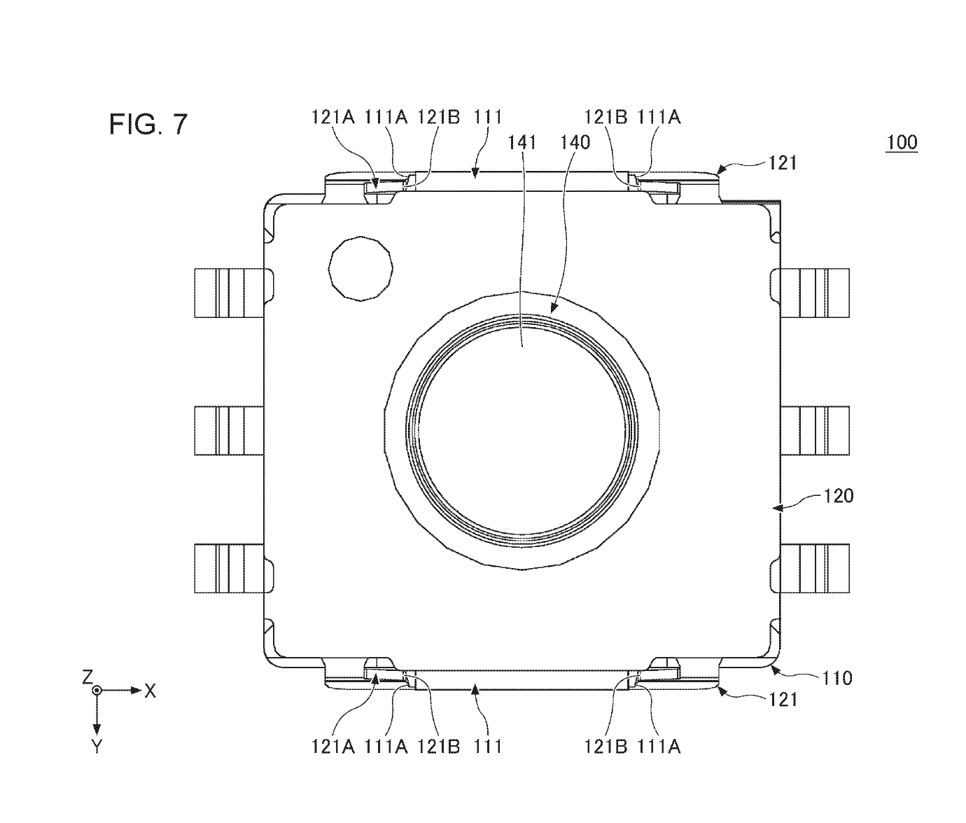

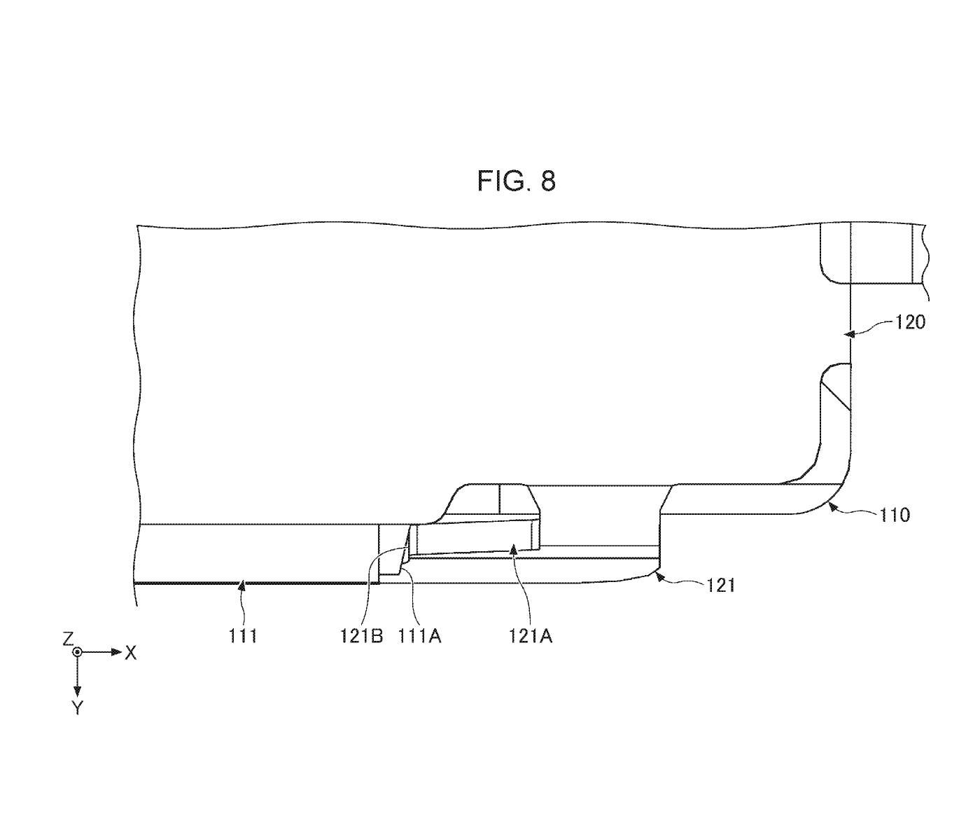

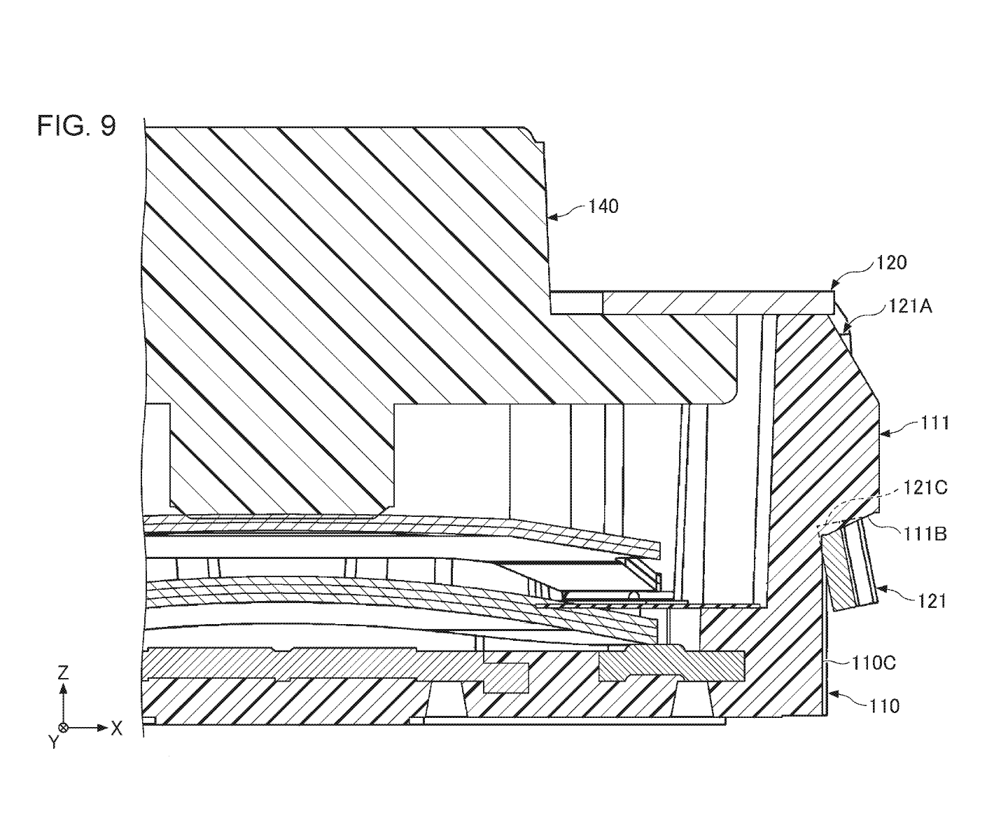

FIG. 5 is a right-side view of the switching apparatus 100 according to one embodiment. FIG. 6 is a partially enlarged view of the switching apparatus 100 illustrated in FIG. 5. FIG. 7 is a plan view of the switching apparatus 100 according to one embodiment. FIG. 8 is a partially enlarged view of the switching apparatus 100 illustrated in FIG. 7. FIG. 9 is a partially enlarged cross-sectional view of the switching apparatus 100 according to one embodiment.

As illustrated in FIG. 5, the opening 121A of the hook 121 on a right side (positive Y-axis side) of the cover member 120 has a lower edge 121C extending in a front-rear direction (X-axis direction) at a lower side (negative Z-axis side) of the opening 121A.

As illustrated in FIG. 5, the opening 121A of the hook 121 on a right side (positive Y-axis side) of the cover member 120 has a pair of side edges 121B extending in the vertical direction (Z-axis direction) at front (positive X-axis side) and rear (negative X-axis side) sides of the opening 121A. In other words, the pair of side edges 121B extend upward (in the positive Z-axis direction) from the opposite ends of the lower edge 121C and face each other.

In contrast, as illustrated in FIG. 5, the protruding portion 111 on a right side (positive Y-axis side) of the housing 110 projects rightward (in the positive Y-axis direction) from a side surface 110C on a right side (positive Y-axis side) of the housing 110.

As illustrated in FIG. 5, the protruding portion 111 on a right side (positive Y-axis side) has a rectangular shape in plan view as viewed from a right side (positive Y-axis direction), with the front-rear direction (X-axis direction) as a longitudinal direction and the vertical direction (Z-axis direction) as a transverse direction.

As illustrated in FIG. 5, in a state in which the cover member 120 is placed over the upper surface 110A of the housing 110, the protruding portion 111 is fitted into the opening 121A of the hook 121, whereby the hook 121 is engaged with the protruding portion 111.

At this time, as illustrated in FIGS. 5 to 9, the lower edge 121C of each hook 121 comes into contact with a lower surface 111B of the protruding portion 111, thereby restricting upward movement (in the positive Z-axis direction) of the hook 121. As a result, engagement of the hook 121 with the protruding portion 111 is further strengthened, and rattling of the cover member 120 relative to the housing 110 in the vertical direction (Z-axis direction) is prevented.

At this time, as illustrated in FIGS. 5 and 6, each of the pair of side edges 121B of the hook 121 comes into contact with a respective one of the pair of side surfaces 111A of the protruding portions 111 (the side surfaces 111A at front (positive X-axis side) and rear (negative X-axis side) sides), thereby restricting movement of the hook 121 in the front-rear direction (X-axis direction). As a result, engagement of the hook 121 with the protruding portion 111 is further strengthened, and rattling of the cover member 120 relative to the housing 110 in the front-rear direction (X-axis direction) is prevented.

Here, as illustrated in FIG. 5, each of the pair of side surfaces 111A of the protruding portion 111 may be an inclined surface (one example of "restricting portion") such that the spacing between the pair of side surfaces 111A increases toward the side surface 110C on a right side (positive Y-axis side) of the housing 110.

In other words, the spacing between the pair of side surfaces 111A of the protruding portion 111 is smallest at a position farthest from the side surface 110C on the right side (positive Y-axis side) of the housing 110, and is largest at a position closest to the side surface 110C on the right side (positive Y-axis side) of the housing 110.

The maximum spacing between the pair of side surfaces 111A of the protruding portion 111 may be greater than the spacing between a pair of side edges 121B of the hook 121. The smallest spacing between the pair of side surfaces 111A of the protruding portion 111 is smaller than the spacing between the pair of side edges 121B of the hook 121.

Accordingly, in the switching apparatus 100 according to one embodiment, the protruding portion 111 can be easily fitted into the opening 121A of the hook 121.

In the switching apparatus 100 according to one embodiment, after the protruding portion 111 is fitted into the opening 121A of the hook 121, the hook 121 is pushed in a rearward direction (negative Y-axis direction), whereby the gap between each of the pair of side edges 121B of the hook 121 and a corresponding one of the pair of side surfaces 111A of the protruding portion 111 can be gradually eliminated.

In the switching apparatus 100 according to one embodiment, by pushing the hook 121 in the rearward direction (negative Y-axis direction) to a predetermined position, each of the pair of side edges 121B of the hook 121 can be brought into contact with a corresponding one of the pair of side surfaces 111A of the protruding portion 111. In other words, the gap between each of the pair of side edges 121B of the hook 121 and a respective one of the pair of side surfaces 111A of the protruding portion 111 can be decreased to zero.

Furthermore, in the switching apparatus 100 according to one embodiment, by pushing the hook 121 from a predetermined position in a further rearward direction (negative Y-axis direction), each of the pair of side edges 121B of the hook 121 can be bitten into a respective one of the pair of side surfaces 111A of the protruding portion 111.

As illustrated in FIGS. 5 to 9, the lower surface 111B of the protruding portion 111 is inclined such that a height position of the lower surface 111B of the protruding portion 111 gradually decreases toward the side surface 110C on a right side (positive Y-axis side) of the housing 110.

Accordingly, in the switching apparatus 100 according to one embodiment, after the protruding portion 111 is fitted into the opening 121A of the hook 121, the hook 121 is pushed in the rearward direction (negative Y-axis direction), whereby the gap between the lower edge 121C of the hook 121 and the lower surface 111B of the protruding portion 111 can be gradually eliminated.

In the switching apparatus 100 according to one embodiment, by pushing the hook 121 in the rearward direction (negative Y-axis direction) to a predetermined position, the lower edge 121C of the hook 121 can be brought into contact with the lower surface 111B of the protruding portion 111.

Furthermore, in the switching apparatus 100 according to one embodiment, by pushing the hook 121 from a predetermined position in a further rearward direction (negative Y-axis direction), the lower edge 121C of the hook 121 can be bitten into the lower surface 111B of the protruding portion 111, as illustrated in FIG. 9.

In other words, in the switching apparatus 100 according to one embodiment, both the lower surface 111B and the pair of side surfaces 111A of the protruding portion 111 are inclined. Accordingly, by pushing the hook 121 in the rearward direction (negative Y-axis direction), each of the lower edge 121C and the pair of side edges 121B of the hook 121 can be bitten into a corresponding one of the lower surface 111B and the pair of side surfaces 111A of the protruding portion 111.

As a result, in the switching apparatus 100 according to one embodiment, movement of the hook 121 relative to the protruding portion 111 in the vertical direction (Z-axis direction) and the front-rear direction (X-axis direction) can be restricted. Accordingly, rattling of the cover member 120 relative to the housing 110 in the vertical direction (Z-axis direction) and the front-rear direction (X-axis direction) is substantially prevented.

In the switching apparatus 100 according to one embodiment, the hook 121 fully bites into the protruding portion 111. Accordingly, even when engagement of the hook 121 with the protruding portion 111 is slightly loosened by reflow heat, only a biting amount is slightly reduced, thereby substantially preventing rattling of the cover member 120 relative to the housing 110.

In contrast, in the conventional switching apparatus, the side surface of the protruding portion of the housing is not inclined, and a certain gap is intentionally provided between the side surfaces of the protruding portion of the housing and the side edges of the hook. For this reason, when engagement of the hook with the protruding portion is slightly loosened by reflow heat, rattling of the cover member corresponding to the gap may occur.

Since the switching apparatus 100 according to one embodiment has a left-right symmetrical structure, the engagement configuration between the hook 121 on a left side (negative Y-axis side) of the cover member 120 and the protruding portion 111 on a left side (negative Y-axis side) of the housing 110 is also the same as the engagement configuration between the hook 121 on a right side (positive Y-axis side) of the cover member 120 and the protruding portion 111 on a right side (positive Y-axis side) of the housing 110.

Accordingly, in the switching apparatus 100 according to one embodiment, movement of the hooks 121 on both left and right sides of the cover member 120 can be restricted, thereby further suppressing rattling of the cover member 120 relative to the housing 110.

Although one embodiment of the present invention has been described in detail above, the present invention is not limited to the embodiment, and various modifications or changes can be made within the scope of the claims of the present invention.

In one embodiment, although the present invention is applied to a switching apparatus configured to be switched on in two stages by a pressing operation, this is illustrative only. In other words, the present invention may be applied to other switching apparatuses (for example, a switching apparatus configured to be switched on in one stage by a pressing operation).

In one embodiment, although each of the pair of side surfaces 111A is inclined, this is illustrative only. Only one of the pair of side surfaces 111A may be inclined.

In one embodiment, although the entire side surface 111A is inclined, part of the side surface 111A may be inclined.

In one embodiment, although "inclined surface" is used as one example of the "restricting portion", this is illustrative only, and configurations other than the "inclined surface" may be used as the "restricting portion".

What is claimed is:

1. A switching apparatus comprising:a housing including an accommodating portioni a fixed contact and a movable contact member disposed in the accommodating portion;an operating member configured to press the movable contact member; anda cover member configured to cover a base portion of the operating member, the cover member including a hook extending downward from an edge of the cover member, the hook having an opening,wherein the housing includes:a protruding portion projecting from a side face of the housing, the protruding portion being configured to fit in the opening, whereby the hook engages the protruding portion;and a restricting portion formed on a pair of side surfaces of the protruding portion, the restricting portion being configured to restrict movement of the hook by coming into contact with a pair of side edges of the opening of the hook.

2. The switching apparatus according to claim 1, wherein the restricting portion comprises at least one inclined surface that is inclined such that a distance
between the pair of side surfaces of the protruding portion increases toward the side faceof the housing.

3. The switching apparatus according to claim 2, wherein the at least one inclined surface comprises a pair of inclined surfaces which are, symmetrically provided on the pair of side surfaces of the protruding portion.

4. The switching apparatus according to claim 3, wherein a maximum distance between the pair of side surfaces of the protruding portion is greater than a spacing between the pair of side edges of the opening.

5. The switching apparatus according to claim 1, wherein the cover member is placed over an upper surface of the housing.
